(19) United States
(12) Patent Application Publication
(10) Pub. No.: US 2009/0192829 A1
(43) Pub. Date: Jul. 30, 2009

(54) Variable product reinsurance

(76) Inventors: Caitlin Long, New York, NY (US); Sean Brady, New York, NY (US); Shane Hadden, Greenwich, CT (US)

Correspondence Address: KING & SPALDING;CREDIT SUISSE SECURITIES (USA) LLC, 1180 PEACHTREE STREET, NE, 34TH FLOOR, ATLANTA, GA, 30309-3521, US

(21) Appl. No.: 12/221,558

(22) Filed: Aug. 4, 2008

Related U.S. Application Data
(63) Continuation of application No. 11/386,555, filed on Mar. 22, 2006, now abandoned.
(60) Provisional application No. 60/664,259, filed on Mar. 22, 2005.

(51) Int. Cl. G06Q 40/00

(52) U.S. Cl. 705/4

(57) ABSTRACT

A Variable Product reinsurance structure including: (i) a reinsurance Agreement between a Variable Product issuer (Ceding Company), and a separate account or Cell of a reinsurer, qualifying for (re)insurance accounting under FAS 133; and (ii) a plurality of derivative instruments qualifying for mark-to-market accounting under FAS 133, designed to hedge exposure to an index of securities that correlates to the specific market risks assumed by the Cell under the Agreement (hedges), purchased for the account of the Cell from multiple dealers, wherein none of the hedge dealers retains more than 50% of the risk of loss. The structure may also include (A) a basis hedge purchased from a third party dealer to hedge other risks assumed by the Cell or (B)(1) a note issued by the Cell, (2) an assumption by the Ceding Company of the risk of non-payment by the hedge dealers and, (3) a contract with an intermediary.

### CROSS-REFERENCE TO RELATED APPLICATIONS

This application is a continuation of U.S. patent application Ser. No. 11/386,555, entitled “Variable Product Reinsurance,” filed Mar. 22, 2006, which claims the benefit of U.S. Provisional Patent Application No. 60/664,259, entitled “Variable Product Reinsurance,” filed Mar. 22, 2005. The complete disclosure of each of the above-identified applications is hereby fully incorporated herein by reference.

### DEFINITIONS

“Variable Product Guarantee Risks” means the risks incurred and reserves required in connection with guarantees issued on a Variable Product (as defined below), such as a guaranteed minimum death benefit (“GMDB”), guaranteed living benefit (“GLB”), guaranteed minimum income benefit (“GMIB”), guaranteed payout annuity floor or other similar guarantee in existence from time to time.

“Variable Product” means a variable annuity, variable life insurance policy, unit-linked contract, equity linked product, equity-indexed annuity and any similar product that may exist from time to time in the U.S. and/or non-U.S. markets, whether sold as part of a base product or as an optional rider to another product.

### BACKGROUND OF THE INVENTION

Reinsurance and risk mitigation mechanisms include, inter alia:

TRADITIONAL REINSURANCE: Reinsurance for Variable Product Guarantee Risks was widely available from approximately the mid-1990s through approximately early 2002 and was provided by traditional reinsurance companies such as Cigna Re, Axa Re and Swiss Re. That early type of reinsurance was generally provided on a proportional basis, i.e., the reinsurers shared proportionally in the profits and losses of the underlying Variable Product with the direct Variable Product issuer. Owing to pricing, regulatory and other considerations, however, that early type of reinsurance has been nearly completely withdrawn from the market or is no longer widely available at pricing the direct Variable Product issuers consider attractive.

HEDGING BY DIRECT VARIABLE PRODUCT ISSUERS: To fill the void for Variable Product Guarantee Risk mitigation caused by the withdrawal of the traditional reinsurers, some direct Variable Product issuers have been purchasing market-hedging products directly via the capital markets. Hedging products are nearly always derivatives and, therefore, must be marked-to-market under FASB Statement No. 133, Accounting for Derivative Instruments and Hedging Activities (“FAS 133”). The major drawback of hedging has been that hedging products are marked-to-market under FAS 133, but the Variable Product issuer's liabilities are accounted for on an accrual basis (i.e., not marked-to-market), resulting in an accounting mismatch.

CAPITAL MARKETS (RE)INSURANCE: Separately, several securities dealers that own insurance or reinsurance affiliates, such as Credit Suisse Securities (USA) LLP (“CSS”), Lehman Brothers and Goldman Sachs, from time to time offer hedging products in insurance or reinsurance form through these affiliates. Insurance and reinsurance is accounted for on an accrual basis—so a Variable Product issuer that purchases this insurance or reinsurance does not have to bear that accounting mismatch—yet the accounting mismatch has not disappeared. Rather, it has merely been transferred onto the consolidated books of the securities dealer itself (which typically buys derivatives to offset the accrual liability that the insurance affiliate has sold). Hence, capacity for such insurance and reinsurance products is limited. The large magnitude of potential earnings swings caused by this accounting mismatch has prevented capital markets (re)insurance solutions from becoming available in large size.

When a securities dealer sells an accrual solution to a client, it can turn to a third-party intermediary to transform its mark-to-market hedges into accrual hedges. In some implementations, the invention eliminates the need for any third-party intermediary involvement by establishing a cell company or sponsored captive whose activities are controlled by a sponsoring entity and then sourcing sufficient hedges through a reinsurance cell without triggering consolidation of the cell onto the sponsoring entity's books.

### SUMMARY

In general, the invention includes a Variable Product reinsurance structure. The structure includes (i) a reinsurance agreement (the “Reinsurance Agreement”) between a Variable Product issuer, in the capacity of ceding company, and a separate account or cell of a reinsurance company, in the capacity of reinsurer (the “Cell”), that qualifies for (re)insurance accounting treatment under FAS 133; and (ii) a plurality of derivative instruments that qualify for mark-to-market accounting treatment under FAS 133 and that are designed to hedge exposure to an index of equity or other securities that correlates to the specific market risks assumed by the Cell under the Reinsurance Agreement (the “Hedges”), purchased for the account of the Cell from multiple dealers (the “Hedge Dealers”) such that none of the Hedge Dealers retains more than 50% of the risk of loss in the Cell. The Variable Product issuer may pay reinsurance premiums either up front or over time. Depending on the payment arrangement, the structure may also include (A) a basis hedge purchased for the account of the Cell from a third party dealer designed to hedge other risks assumed by the Cell in connection with the Reinsurance Agreement or (B)(1) a note (the “Note”) issued by the Cell to an investor (the “Noteholder”), (2) an assumption by the Ceding Company of the risk of non-payment by the Hedge Dealers and, potentially, (3) a contractual arrangement with a reinsurance intermediary involving a fee for services.

Implementations may include one or more of the following features: the Reinsurance Agreement may be a retrocession agreement, in which case the ceding company would be a reinsurance company that has reinsured Variable Products and the Cell would be a separate account or cell of another reinsurance company. Implementations may also include other features.

In general, in another aspect, the invention includes a Variable Product reinsurance mechanism that delivers the protection described above (i.e., to insurers and/or reinsurers that issued or reinsured Variable Products that expose them to Variable Product Guarantee Risks) in a form and substance that qualifies as reinsurance for accounting purposes. By being treated as reinsurance for accounting purposes, implementations may reduce or eliminate the accounting mismatch inherent in alternatives that are widely available to insurers and reinsurers at present. In some implementations, this is done by combining two key structuring features: (i) a cell that qualifies as a variable interest entity whose expected loss is hedged with at least three counterparties, i.e., no single party assumes more than 50% of the risk of loss in the cell, thus eliminating the need to consolidate the cell, and (ii) linking of the reinsurance benefit payments to mortality via payment based on incurred guaranteed death benefit claims, with a cap (“Cap”). The Cap may either be a dollar amount or an amount that references returns on an agreed index, such as the S&P500 or a basket of indices, during a reference period.

Comparison with Direct Hedging and Capital Markets (Re)Insurance: Implementations may solve the accounting mismatch problem that has made unattractive current alternatives, i.e., the direct hedging and capital markets reinsurance discussed above. By using a variable interest entity and a method whereby less than 50% of the expected loss of a separate account or cell is borne by each single party, the accounting mismatch still exists using the Variable Product reinsurance mechanism disclosed herein, but need not be consolidated anywhere (i.e., not on the books of the direct Variable Product issuer or on the books of the entity that owns the insurance company of which the Cell is a part). This addresses the major drawback of hedging for direct Variable Product issuers, namely that they bear an accounting mismatch, and it addresses the major drawback of capital markets (re)insurance for the owner of an insurance or reinsurance company, namely, that the owners bear an accounting mismatch. Implementations can be structured such that the accounting mismatch rests with neither party.

Generally speaking, solving the accounting mismatch alone does not qualify the Reinsurance Agreement as reinsurance—so the second structural feature, the linking of reinsurance benefit payments to mortality via payment based on incurred guaranteed death benefit claims, with a Cap, is also critical. To qualify as (re)insurance under US GAAP and to avoid mark-to-market accounting treatment under FAS 133, the Reinsurance Agreement must transfer underwriting risk—in this case mortality risk—and the reinsurer must have a reasonable possibility of realizing a significant loss. The Reinsurance Agreement meets these tests by linking reinsurance benefits to incurred death benefits. However, so that the user of the Variable Product reinsurance mechanism disclosed herein does not assume unlimited exposure to guaranteed death benefits—a risk that cannot be hedged in size—that exposure is capped pursuant to the Cap.

Comparison with Traditional Reinsurance: Traditional reinsurance for Variable Product Guarantee Risks that was widely available until approximately early 2002 was generally proportional reinsurance—the reinsurers shared proportionally in the profits and losses of the underlying Variable Product with the direct Variable Product issuer. In contrast, the reinsurance mechanism disclosed herein enables the reinsurer to isolate only the market risks and a capped death benefit risk (i.e., the inherent mortality risk assumed by issuers of guaranteed death benefits) while leaving all other risks, such as expense risk, lapse risk, operational risk, residual mortality risk, etc., at the ceding company.

(Proportional Structure only: While other insurance companies have used similar structures to transfer risk to an offshore affiliate, and subsequently to carve out a specific portion of that risk and retrocede it to a third-party reinsurance company, this has never before been accomplished in combination with the death benefit cap and accounting mismatch solutions described herein.)

### DESCRIPTION OF THE DRAWINGS

FIGS. 1, 2, 3 and 4 are block diagrams showing business entity structures that may be used in implementations of the invention.

### DETAILED DESCRIPTION OF THE INVENTION

Implementations of a variable product reinsurance mechanism can provide (i) reinsurance of Variable Product Guarantee Risks (as defined above) to insurance companies and (ii) retrocessional coverage for reinsurance companies that reinsure Variable Product Guarantee Risks.

Implementations may include one or more of the following benefits. Implementations (i) may provide protection for Variable Product Guarantee Risks that qualifies for treatment as a reinsurance product under FAS 133, (ii) may avoid consolidation of the reinsurance company providing protection, or any separate account or cell thereof, with any other entity pursuant to FASB Interpretation No. 46(R), Consolidation of Variable Interest Entities (“FIN 46”), thereby reducing or solving the accounting mismatch problem inherent in the alternative products and strategies currently available to manage or provide protection for Variable Product Guarantee Risks, and (iii) may provide reserve, capital or surplus relief for insurance and reinsurance companies that have assumed Variable Product Guarantee Risks intended to be addressed by National Association of Insurance Commissioners (“NAIC”) Actuarial Guideline VACARVM or any modification, amendment or successor thereto, the NAIC risk-based capital (RBC) guidelines (including, without limitation, the C-3 Phase II project) or any other similar actuarial, accounting or insurance or reinsurance regulatory regimes within or outside the United States.

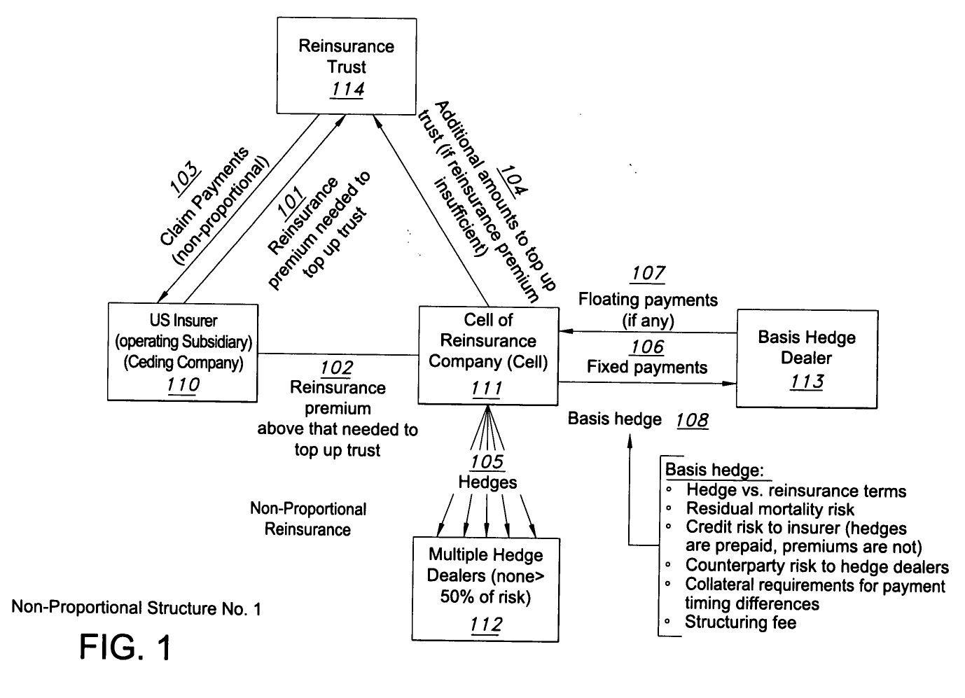

Referring to FIG. 1, the variable product reinsurance method may include (i) a reinsurance or retrocession agreement (the “Reinsurance Agreement”) between (a) an insurance company that has issued Variable Products or a reinsurance company that has reinsured Variable Products (the “Ceding Company”) 110 and (b) a separate account or cell of a reinsurance company (the “Cell”) 111, (ii) several derivative instruments (the “Hedges”) 105 purchased by the Cell from multiple dealers (the “Hedge Dealers”) 112, such that none of the Hedge Dealers retains more than 50% of the risk of loss in the Cell and (iii) a separate hedge (the “Basis Hedge”) purchased from CSS or another third party dealer (the “Basis Hedge Dealer”) 113. Pursuant to the Reinsurance Agreement, the Ceding Company 110 cedes Variable Product Guarantee Risks to the Cell 111 on a non-proportional or carve-out basis, i.e., only isolated risks will be transferred, unlike a traditional proportional or quota share reinsurance arrangement where a fixed percentage of all risks is transferred. Under one embodiment of the Variable Product reinsurance method, the Reinsurance Agreement under the Non-Proportional Structure No. 1 of FIG. 1 will also provide that assets equal at least to the reserves for Variable Product Guarantee Risks transferred to the Cell will be held in a trust account (the “Reinsurance Trust”) 114 for the benefit of the Ceding Company 110 as collateral for claim payments, such that the Ceding Company is able to take credit on its statutory financial statements for risks ceded. Under this embodiment, the Reinsurance Trust will be funded at the closing of a transaction by a transfer of assets from the Ceding Company equal to such reserves, net of a ceding commission. The remainder of the amount required to be deposited in the Reinsurance Trust 114 at closing will be from assets in the Cell 111. Thereafter, the Reinsurance Trust will be funded to the extent necessary to have a market value at least equal to the reserves transferred under the Reinsurance Agreement through a combination of reinsurance premium payments from the Ceding Company and additional top-ups 104, if necessary, from the Cell.

The Hedges 105 will provide the Cell 111 protection against a reduction in a market index that correlates to the specific Variable Product Guarantee Risks being reinsured. The Basis Hedge 108 obtained from the Basis Hedge Dealer 113 will provide protection against all basis risk remaining in the Cell 111 after taking into account the Hedges 105, including risks related to the terms of the Reinsurance Agreement, residual mortality risk, credit risk to the Ceding Company 110 (i.e., risk that reinsurance premiums are not paid), counterparty credit risk to the Hedge Dealers 112 (i.e., risk that payments are not made under the Hedges), payment timing risk under the Reinsurance Agreement (if a Reinsurance Trust or other collateral structure is used), a structuring fee, and any other residual risks. The Hedges 105 and the Basis Hedge 108 may take the form of one or more, or any combination of, swaps, options, warrants, caps, floors, collars, swaptions, forwards, futures or any other derivative contracts or instruments that qualify for mark-to-market accounting treatment under FAS 133.

Periodic fixed cash flows associated with the variable product reinsurance method include ongoing payments of reinsurance premium by the Ceding Company 110 to the Cell 111 under the Reinsurance Agreement, fixed payments by the Cell 111 to the Hedge Dealers 112 under the Hedges 105 and fixed payments by the Cell 111 to the Basis Hedge Dealer 113 under the Basis Hedge 108. Floating payments, if any, include floating payments 107 by the Basis Hedge Dealer 113 to the Cell 111 under the Basis Hedge 108, floating payments by the Hedge Dealers to the Cell under the Hedges 105 and claim payments by the Cell 111 to the Ceding Company 110 under the Reinsurance Agreement.

FIG. 1 shows the post-closing cash flows under Non-Proportional Structure No. 1, including, for illustrative purposes only, cash flows to and from a Reinsurance Trust. Elements 101-102 demonstrate how reinsurance premiums payable by the Ceding Company 110 to the Cell 111 in respect of Variable Product Guarantee Risks assumed under the Reinsurance Agreement are bifurcated, with cash flows 101 going first to the Reinsurance Trust 114 to the extent necessary to bring the value of assets in the Reinsurance Trust 114 up to the amount of reserves transferred under the Reinsurance Agreement. The Ceding Company 110 pays the remainder 102 of reinsurance premium due under the Reinsurance Agreement directly to the Cell 111. When the Ceding Company is required to pay losses covered under the Reinsurance Agreement, assets in the Reinsurance Trust are liquidated and funds 103 released from the Reinsurance Trust to the Ceding Company 110 to indemnify the Ceding Company 110 for such losses. Flow 104 represents the Cell's obligation to top-up the Reinsurance Trust in the event that the value of assets in the Reinsurance Trust, after giving effect to a periodic transfer to the Reinsurance Trust of the entire reinsurance premium then due, is less that the amount of reserves required to be maintained by the Cell. Flows 101-104 of Non-Proportional Structure No. 1, including sufficient transfer of mortality risk from the Ceding Company 110 to the Cell 111, combine to permit the Ceding Company to account for the Reinsurance Agreement on an accrual rather than a mark-to-market basis under FAS 133.

The array of cash flows 105 represent the Hedges with multiple Hedge Dealers 112. Hedges 105 permit any accounting mismatch between reinsurance accounting on an accrual basis and derivatives accounting on a mark-to-market basis to remain in the Cell 111. Each of the Hedges 105 will be characterized as derivatives for accounting purposes, and the Cell 111 and the Hedge Dealers 112 will account for the Hedges on a mark-to-market basis. Since no one Hedge Dealer will be exposed to more than 50% of the risk assumed by the Cell 111, neither the Hedge Dealers 112 nor the Basis Hedge Dealer 113 will be required to consolidate the Cell on its books, thus eliminating the accounting mismatch for the Hedge Dealers 112 and the Basis Hedge Dealer 113.

Cash flow 106 is the fixed payments by the Cell to the Basis Hedge Dealer and 107 represents the floating payment obligation of the Basis Hedge Dealer 113 under the Basis Hedge 108. The Basis Hedge is preferably structured to make the variable product reinsurance mechanism palatable from a commercial perspective to Ceding Companies 110 and Hedge Dealers 112, one or more of which would otherwise be required to retain or assume the risks transferred under the Basis Hedge 108.

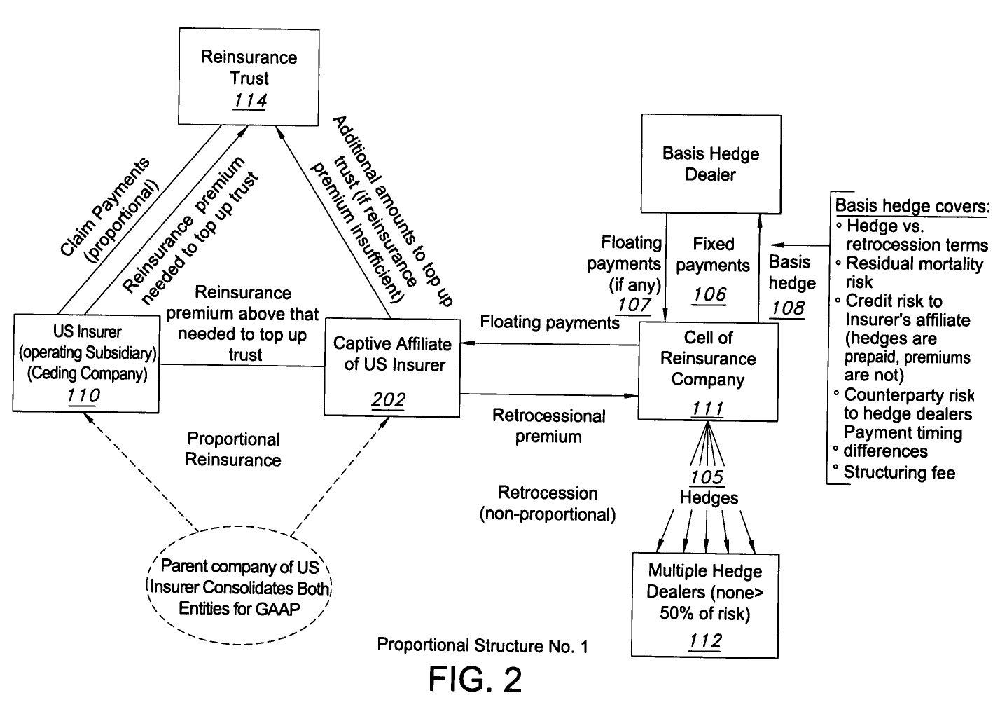

FIG. 2 shows the post-closing cash flows under Proportional Structure No. 1, including cash flows to and from the Reinsurance Trust (for illustrative purposes only). Proportional Structure No. 1 is substantially similar in economic effect to Non-Proportional Structure No. 1, except that proportional reinsurance risks under Variable Products are passed first through a captive insurance company 202 affiliated with the Ceding Company (the “Captive”), and then non-proportional Variable Product Guarantee risks are retroceded (i.e., re-reinsured) to the Cell pursuant to a retrocession agreement (the “Retrocession Agreement”). In Proportional Structure No. 1, the Reinsurance Trust acts as collateral for the Cell's obligations to pay claims under an underlying reinsurance agreement between the Ceding Company and the captive (the “Underlying Reinsurance Agreement”). Since assets equal to the reserves transferred in the Underlying Reinsurance Agreement would be maintained (trapped) in the Reinsurance Trust, the cession of risk under the Retrocession Agreement would necessarily be on a funds withheld basis, i.e., rather than the Captive transferring assets to a reinsurance trust as collateral, the Captive would have an unsecured claim against the Cell for claim payments in the form of a receivable. Proportional Structure No. 1 is intended as an alternative for Ceding Companies that desire to cede risks under Variable Products on a traditional proportional basis. The isolation of non-proportional risk under Proportional Structure No. 1 is achieved at the level of the Retrocession Agreement.

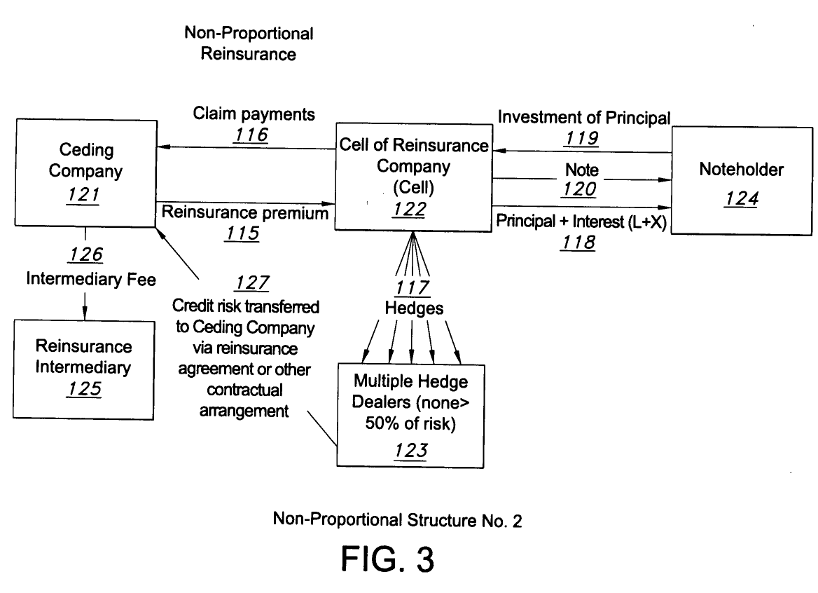

FIG. 3, another embodiment of the invention, shows the post-closing cash flows under Non-Proportional Structure No. 2. Element 126 shows the fees to be paid to a reinsurance intermediary 125 for services rendered. Element 115 shows the flow of reinsurance premiums payable by the Ceding Company 121 to the Cell 122 in respect of Variable Product Guarantee Risks ceded and assumed under the Reinsurance Agreement. The Ceding Company 121 pays all reinsurance premiums due under the Reinsurance Agreement directly to the Cell 122, possibly in advance at the beginning of the term of the Reinsurance Agreement. Flow 116 shows the flow of claim payments from Cell 122 to Ceding Company 121. Elements 115 and 116 of Non-Proportional Structure No. 2, including sufficient transfer of death benefit risk from the Ceding Company 121 to the Cell 122, combine to permit the Ceding Company to account for the Reinsurance Agreement on an accrual rather than a mark-to-market basis under FAS 133.

The array of cash flows 117 represent the Hedges with multiple Hedge Dealers 123. Hedges 117 permit any accounting mismatch between reinsurance accounting on an accrual basis and derivatives accounting on a mark-to-market basis to remain in the Cell 122. Each of the Hedges 117 will be characterized as derivatives for accounting purposes, and the Cell 122 and the Hedge Dealers 123 will account for the Hedges on a mark-to-market basis. The credit risk of the Hedge Dealers 123 will be transferred to the Ceding Company 121.

Cash flow 119 represents the investment by the Noteholder 124 in the Note 120 issued by the Cell. Cash flow 118 represents the principal and interest payments by the Cell to the Noteholder 124. An assumption by the Ceding Company of the risk of non-payment by the Hedge Dealers 127 may be implemented through a provision in the reinsurance or retrocessional agreement or through another contractual arrangement.

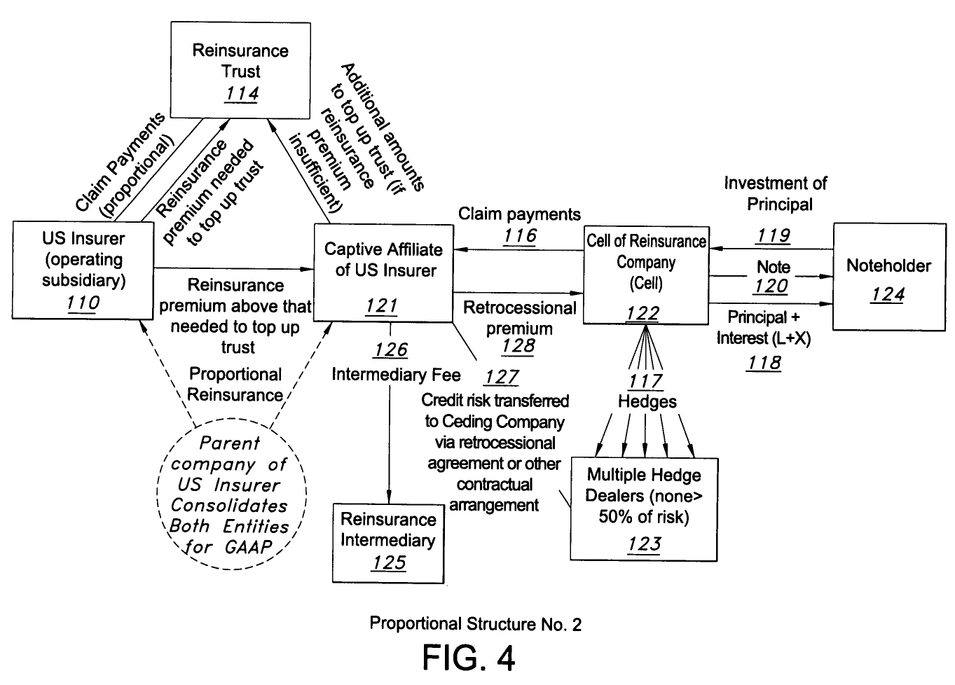

FIG. 4 (Proportional Structure No. 2) is another embodiment of the invention and combines elements of Proportional Structure No. 1 with the non-proportional reinsurance elements found in Non-Proportional Structure No. 2.

FIG. 4, shows the post-closing cash flows to and from the Reinsurance Trust (for illustrative purposes only). Proportional reinsurance risks under Variable Products are passed through a captive insurance company (the “Captive”) 121 affiliated with a ceding company (the “Ceding Company”) 110. The Reinsurance Trust provides security for the Captive's obligations to pay claims under a reinsurance agreement between the Ceding Company 110 and the Captive (the “Reinsurance Agreement”). Since assets equal to the reserves transferred under the Reinsurance Agreement would be maintained in the Reinsurance Trust, the cession of risk under a retrocessional agreement between the Captive 121 and Cell 122 (the “Retrocessional Agreement”) would be on a funds withheld basis, i.e., the Captive would hold assets instead of transferring them to the Cell in connection with the retrocession of reserve liabilities.

FIG. 4 also contains non-proportional elements substantially similar to that of Non-Proportional Structures No. 2. Proportional Structure No. 2 in FIG. 4 is intended as an alternative for ceding companies that desire to cede risks under Variable Products using a captive insurance company as a reinsurer and the Cell as a retrocessionaire for the captive insurer. The isolation of non-proportional risk under Proportional Structure No. 2 is achieved at the level of the Retrocession Agreement. Element 126 shows the fees to be paid to Reinsurance Intermediary 125 for services rendered. Element 128 shows the flow of retrocessional premiums payable by the Captive 121 to the Cell 122 in respect of Variable Product Guarantee Risks ceded and assumed under the Retrocessional Agreement. The Captive 121 pays all premiums due under the Retrocessional Agreement directly to the Cell 122, possibly in advance at the beginning of the term of the Retrocessional Agreement. Flow 116 shows the flow of claim payments from the Cell 122 to the Captive 121. Elements 128 and 116, including sufficient transfer of death benefit risk from the Captive 121 to the Cell 122, combine to permit the Captive to account for the Retrocessional Agreement on an accrual rather than a mark-to-market basis under FAS 133.

The array of cash flows 117 represent the Hedges with multiple Hedge Dealers 123. Hedges 117 permit any accounting mismatch between reinsurance accounting on an accrual basis and derivatives accounting on a mark-to-market basis to remain in Cell 122. Each of the Hedges 117 will be characterized as derivatives for accounting purposes, and Cell 122 and the Hedge Dealers 123 will account for the Hedges on a mark-to-market basis. The credit risk of the Hedge Dealers 123 will be transferred to Captive 121.

Cash flow 119 represents the investment by the Noteholder 124 in the Note 120 issued by Cell 122. Cash flow 118 represents the principal and interest payments by Cell 122 to the Noteholder 124. An assumption by the Captive of the risk of non-payment by the Hedge Dealers 127 may be implemented through a provision in the Reinsurance Agreement or Retrocessional Agreement or through another contractual arrangement.

The variable product reinsurance mechanism combines the foregoing elements and cash flows in a novel way and could be used to provide for the following three desired results:

1. Insurance Accounting and the “Death Benefit Cap”

The Reinsurance Agreement component of the Variable Product reinsurance mechanism will be accounted for on an accrual basis, and will not be marked-to-market under FAS 133 because the Reinsurance Agreement qualifies under FAS 113, as a long-term (re)insurance contract. This qualification arises from (a) the transference by the Reinsurance Agreement of underwriting risk—in this case mortality risk inherent in guaranteed death benefits—and (b) the reasonable possibility that the Cell will realize a significant loss. As a result, the variable product reinsurance mechanism qualifies for the insurance exemption to FAS 133, and the Reinsurance Agreement will be accounted for on an accrual basis and will not be marked-to-market.

Although death benefit risk is transferred, the amount of potential reinsurance benefits is capped. In one implementation, the cap may be set at a fixed amount of death benefits. In another implementation, the cap may be expressed as the amount of losses that would be incurred on an agreed upon reference portfolio. The reference portfolio could be a commonly used index, such as the Standard and Poor's 500 Index, a combination of market indices or another basket.

2. Solving the Accounting Mismatch: Use of Cell Company and Use of Multiple Dealers by the Cell to Execute Hedge

In some implementations, derivatives may be transformed into reinsurance and reinsurance into derivatives for accounting purposes. Under FAS 133, a counterparty to a derivative contract is required to account for the derivative by “marking it to market” on the counterparty's financial statements. On the other hand, the insurance exception to FAS 133 provides that a counterparty to a reinsurance agreement is required to account for the reinsurance agreement on an accrual basis rather than by “marking it to market.” This is accomplished by (a) employing the Cell rather than the general account of an insurance company, (b) the Cell qualifying as a variable interest entity under FIN 46, (c) the Cell buying protection (out the “back end”) under the Hedges that would be marked-to-market under FAS 133 and selling protection (out the “front end”) in the form of reinsurance that would be accounted for on an accrual basis under FAS 133, and (d) executing the “back end” derivatives through multiple Hedge Dealers so that none of the Hedge Dealers retains more than 50% of the risk of loss in the Cell. Since the Cell has no primary beneficiary (i.e., no single entity bears more than 50% of the risk of loss in the Cell), the Cell need not be consolidated by any entity under FIN 46. Consequently, the accounting mismatch between the protection sold through “front end” reinsurance and bought through “back end” derivatives remains in the unconsolidated Cell.

3. (Proportional Structure Only—FIG. 2) Creation of Proportional Reinsurance: Inserting the Client's Offshore Affiliate

The reinsurance protection provided in accordance with this disclosure may be purchased by an offshore insurance company under common control with (but not a subsidiary of) of a U.S. domiciled insurance company (the “Offshore Affiliate”), rather than by an insurance company domiciled in the United States. The Offshore Affiliate could then offer proportional reinsurance to the U.S. domiciled insurance company. This enables the U.S. domiciled insurance company to achieve reserve relief for Variable Product Guarantee Risks under the applicable provisions of the NAIC's Accounting Practices and Procedures Manual while also achieving accrual treatment under FAS 133 (i.e., under generally accepted accounting principles (GAAP)) for the market protection provided by variable product reinsurance mechanism disclosed herein. The accounting mismatch described above between the “front-end” reinsurance and the “back-end” derivative would be retained by the Cell. From the perspective of the U.S. domiciled insurance company's parent company (its GAAP reporting entity), the net effect of (1) its contract with its Offshore Affiliate and (2) its Offshore Affiliate's contract with the Cell disappears upon consolidation under US GAAP.

Implementations may allow U.S. domiciled insurance companies (and other insurance companies that report their financial results under U.S. GAAP) to mitigate risks associated with Variable Product Guarantee Risks that the insurance companies have assumed on Variable Products they sold. Guarantees may include such types as guaranteed minimum death benefits (GMDBs), guaranteed living benefits (GLBs), guaranteed minimum income benefits (GMIBs), guaranteed payout annuity floors, or other similar minimum performance guarantees. They also include such features known in the market as ratchets, roll-ups, and resets.

The invention may be implemented in digital electronic circuitry, or in computer hardware, firmware, software, in combinations of the foregoing or in non-computer forms (e.g., using manually performed calculations and record keeping). In computerized implementations, apparatus of the invention may be implemented in a computer program product tangibly embodied in a machine-readable storage device for execution by a programmable processor; and method steps of the invention may be performed by a programmable processor executing a program of instructions to perform functions of the invention by operating on input data and generating output. The invention may advantageously be implemented in one or more computer programs that are executable on a programmable system including at least one programmable processor coupled to receive data and instructions from, and to transmit data and instructions to, a data storage system, at least one input device, and at least one output device.

A number of embodiments of the present invention have been described. Nevertheless, it will be understood that various modifications may be made without departing from the spirit and scope of the invention. For example, although a particular reinsurance trust structure has been described, implementations may involve alternative methods for the Ceding Company to obtain statutory reinsurance ceded credit (e.g., a letter of credit or a “funds withheld” arrangement) or may involve a reinsurer that is sufficiently licensed so that a reinsurance collateral arrangement is not necessary for the Ceding Company to obtain statutory reinsurance ceded credit. In addition, implementations may alter the form of the Hedges and/or the Basis Hedge, or if no Basis Hedge is used, the form of the Note. Further, implementations may alter the form of the entity that provides protection under the Reinsurance Agreement, e.g., it may be a special purpose insurance or reinsurance company. Accordingly, other embodiments are within the scope of the invention.

1. (canceled)

2. (canceled)

3. (canceled)

4. (canceled)

5. A method for providing variable product reinsurance, comprising the steps of:
creating a reinsurance agreement “between a ceding company and a Cell of a reinsurance company”, the reinsurance agreement transferring a risk of loss from the ceding company to the Cell of the reinsurance company; and
purchasing a plurality of hedges designed to hedge exposure to the risk of loss transferred to the cell under the reinsurance agreement, “the hedges being purchased for the account of the Cell from a plurality of hedge dealers” such that each of the hedge dealers retains less than 50% of the risk of loss in the Cell.

6. The method of claim 5, wherein the reinsurance agreement comprises a retrocession agreement.

7. The method of claim 5, wherein the ceding company comprises one of an insurance company that has issued a variable product and a reinsurance company that has reinsured a variable product.

8. The method of claim 5, wherein the Cell of the reinsurance company qualifies for reinsurance accounting treatment under FAS 133.

9. The method of claim 5, wherein the ceding company comprises an entity that has reinsured a variable product,
the method further comprising the step of creating another reinsurance agreement between an issuer and the ceding company,
wherein the reinsurance agreement between the ceding company and the Cell of the reinsurance company is a retrocession agreement.

10. The method of claim 5, further comprising the step of holding assets for the benefit of the ceding company in a reinsurance trust, the assets being equal to at least reserves of the risk of loss transferred to the Cell under the reinsurance agreement.

11. The method of claim 5, further comprising the step of transferring a credit risk associated with each of the hedge dealers from the Cell to the ceding company.

12. The method of claim 5, further comprising the step of purchasing a basis hedge for benefit of the Cell, the basis hedge providing a hedge for at least one risk other than the risk of loss transferred to the Cell under the reinsurance agreement.

13. The method of claim 12, wherein the basis hedge provides a hedge for at least one of a residual mortality risk, a credit risk of at least one of the hedge dealers to the ceding company, a counter-party credit risk to at least one of the hedge dealers, and risks relating to terms in the reinsurance agreement other than the specific risk assumed by the Cell under the reinsurance agreement.

14. The method of claim 5, further comprising the step of limiting the risk of loss transferred to the Cell under the reinsurance agreement via a benefit cap.

15. The method of claim 14, wherein the risk of loss is based on a mortality risk, and wherein the benefit cap comprises a death benefit cap that limits the mortality risk.

16. A computer-readable medium having computer-executable instructions for performing the computer-implemented method of claim 5.

17. A method for providing variable product reinsurance, comprising the steps of:
transferring an underwriting risk from a ceding company to a Cell of a reinsurance company via a first reinsurance agreement between the ceding company and the Cell of the reinsurance company, the underwriting risk based on guaranteed benefits of at least one variable product;
purchasing a plurality of hedges that hedge exposure of the Cell of the reinsurance company to the underwriting risk transferred to the Cell under the reinsurance agreement, the hedges being purchased from a plurality of hedge dealers for a benefit of the Cell such that each of the hedge dealers retains less than 50% of the underwriting risk transferred to the Cell; and
limiting the underwriting risk transferred to the Cell via a benefit cap.

18. The method of claim 17, wherein the ceding company is an insurance company that has issued the at least one variable product.

19. The method of claim 17, wherein the ceding company is an affiliate of an issuer that has issued the at least one variable product,
the method further comprising the step of transferring risks related to the at least one variable product to the ceding company via a separate reinsurance agreement between the issuer and the ceding company,
wherein the reinsurance agreement between the ceding company and the Cell of the reinsurance company is a retrocession agreement for the at least one variable product.

20. The method of claim 19, wherein the first reinsurance agreement is a non-proportional reinsurance agreement, and wherein the separate reinsurance agreement is a proportional reinsurance agreement.

21. The method of claim 17, further comprising the step of transferring a credit risk associated with each of the hedge dealers from the Cell to the ceding company.

22. The method of claim 17, further comprising the step of holding assets for a benefit of the ceding company in a reinsurance trust, the assets based on a reserve of the underwriting risk transferred to the Cell by the ceding company.

23. The method of claim 22, wherein the assets held in the trust comprise at least one of premium payments paid by the ceding company to the Cell of the reinsurance company for the reinsurance agreement and payments by the ceding company to account for any deficiency in the assets.

24. The method of claim 17, further comprising the step of purchasing a basis hedge for the Cell, the basis hedge providing a hedge for risks other than the underwriting risk.

25. The method of claim 24, wherein the basis hedge provides a hedge for risks associated with at least one of a residual mortality risk, a credit risk of at least one of the hedge dealers to the ceding company, a counter-party credit risk to at least one of the hedge dealers, and risk relating to terms in the reinsurance agreement other than the underwriting risk.

26. The method of claim 17, wherein the underwriting risk is based on a mortality risk, and wherein the benefit cap comprises a death benefit cap that limits the mortality risk transferred to the Cell of the reinsurance company.

27. A computer-readable medium having computer-executable instructions for performing the computer-implemented method of claim 17.

28. A method for creating a reinsurance agreement that controls accounting consolidation of a Cell of a reinsurance company, comprising the steps of:
creating the Cell as a separate account of the reinsurance company;
establishing a reinsurance agreement between the Cell and an insurance entity, the reinsurance agreement transferring a specific risk from the insurance entity to the Cell; and
purchasing a plurality of hedges from a plurality of hedge dealers for the Cell, each of the hedges being designed to hedge exposure to the specific risk transferred to the Cell under the reinsurance agreement,
wherein none of the hedge dealers are required to consolidate the Cell for accounting purposes.

29. The method of claim 28, wherein none of the hedge dealers are required to consolidate the Cell for accounting purposes because each of the hedge dealers retains less than 50% of a risk of loss in the Cell based on the specific risk transferred to the Cell under the reinsurance agreement.

30. The method of claim 28, further comprising the step of issuing a note by the Cell to a noteholder, the note designed to hedge at least one risk assumed by the Cell under the reinsurance agreement other than the specific risk transferred to the Cell under the reinsurance agreement,
wherein the noteholder is not required to consolidate the Cell for accounting purposes.

31. The method of claim 28, further comprising the step of entering into a basis hedge agreement between the Cell and a third party dealer, the basis hedge designed to hedge at least one risk assumed by the Cell under the reinsurance agreement other than the specific risk transferred to the Cell under the reinsurance agreement,
wherein the third party dealer is not required to consolidate the Cell for accounting purposes.

32. The method of claim 31, wherein the basis hedge provides at least one hedge for a risk associated with at least one of a residual mortality risk, a credit risk to the ceding company, a counter-party credit risk to one of the hedge dealers, and risk relating to terms in the reinsurance agreement other than the specific risk.

33. The method of claim 28, wherein the reinsurance agreement comprises a retrocession agreement.

34. The method of claim 33, wherein the insurance entity is a captive affiliate of an issuer,
the method further comprising the step of establishing an agreement between the issuer and the insurance entity to reinsure a variable product issued by the issuer and to transfer risk related to the variable product from the issuer to the insurance entity,
wherein the specific risk transferred from the insurance entity to the Cell comprises an isolated portion of the risk transferred from the issuer to the insurance entity.

35. The method of claim 34, further comprising the step of transferring assets from the issuer to a trust, wherein the trust holds assets equal to at least reserves of risk transferred to the insurance entity.

36. The method of claim 28, wherein the insurance entity comprises one of an insurance company that has issued a variable product and a reinsurance company that has reinsured a variable product.

37. The method of claim 28, further comprising the step of transferring assets from the insurance entity to a trust, wherein the trust holds assets equal to at least reserves of the specific risk transferred to the Cell under the reinsurance agreement.

38. The method of claim 28, wherein the reinsurance agreement comprises a benefit cap that limits the specific risk transferred to the Cell of the reinsurance company.

39. The method of claim 28, wherein the specific risk transferred to the Cell of the reinsurance company comprise a mortality risk, the method further comprising the step of implementing a death benefit cap that limits the mortality risk transferred to the Cell of the reinsurance company.

40. A computer-readable medium having computer-executable instructions for performing the computer-implemented method of claim 28.

41. A method for providing variable product reinsurance, comprising the steps of:
providing a proportional reinsurance agreement between an insurance issuer and an affiliate of the issuer, the proportional reinsurance agreement transferring a proportional amount of insurance risk from the issuer to the affiliate, the insurance risk based on a variable product issued by the issuer and reinsured by the affiliate under the proportional reinsurance agreement;
providing a non-proportional retrocession reinsurance agreement between the affiliate and a Cell of a reinsurance company, the retrocession agreement transferring an isolated portion of the insurance risk from the affiliate to the Cell of the reinsurance company;
obtaining a plurality of hedges that hedge exposure of the Cell of the reinsurance company to the isolated portion of the insurance risk transferred to the Cell under the retrocession agreement, the hedges being purchased from a plurality of hedge dealers for a benefit of the Cell such that each of the hedge dealers retains less than 50% of the isolated portion of the insurance risk transferred to the Cell and such that none of the hedge dealers are required to consolidate the Cell for accounting purposes; and
limiting the isolated portion of the insurance risk transferred to the Cell via a benefit cap.

42. The method of claim 41, further comprising the step of transferring a credit risk associated with each of the hedge dealers from the Cell to the affiliate.

43. The method of claim 41, further comprising the step of holding assets for a benefit of the issuer in a trust, the assets based on a reserve of the insurance risk transferred to the affiliate by the issuer.

44. The method of claim 43, wherein the assets held in the trust comprise at least one of premium payments paid by the issuer to the affiliate for the proportional reinsurance agreement and payments by the affiliate to account for a deficiency in the assets.

45. The method of claim 41, further comprising the step of purchasing a basis hedge for a benefit of the Cell, the basis hedge providing a hedge for risks other than the isolated portion of the insurance risk transferred to the Cell under the retrocession agreement.

46. The method of claim 45, wherein the basis hedge provides a hedge for risks associated with at least one of a residual mortality risk, a credit risk of at least one of the hedge dealers to the ceding company, a counter-party credit risk to at least one of the hedge dealers, a structural fee, and risks relating to terms in the retrocession agreement other than the isolated portion of the insurance risk transferred to the Cell under the retrocession agreement.

47. The method of claim 41, wherein the isolated portion of the insurance risk is based on a mortality risk, and wherein the benefit cap comprises a death benefit cap that limits the mortality risk transferred to the Cell.

48. A method for providing variable product reinsurance, comprising the steps of:
executing a reinsurance agreement for a variable product between an insurance entity and a Cell of a reinsurance company, wherein the Cell of the reinsurance company assumes via the reinsurance agreement at least one specific underwriting risk related to the variable product;
purchasing a plurality of hedges that hedge exposure of the Cell to the at least one risk assumed by the Cell under the reinsurance agreement, the hedges being purchased from a plurality of hedge dealers and being designed such that none of the hedge dealers are required to consolidate the Cell for accounting purposes; and
limiting the at least one risk assumed by the Cell via a benefit cap.
